(19) United States
(12) Patent Application Publication
(10) Pub. No.: US 2019/0267936 A1
(43) Pub. Date: Aug. 29, 2019

(54) MAINTENANCE VEHICLES FOR SOLAR PHOTOVOLTAIC POWER PLANTS

(71) Applicant: Alion Energy, Inc., Richmond, CA (US)

(72) Inventors: Søren Jensen, Corte Madera, CA (US); Craig B. E. Wildman, Kensington, CA (US)

(21) Appl. No.: 16/286,291

(22) Filed: Feb. 26, 2019

Related U.S. Application Data
(60) Provisional application No. 62/636,051, filed on Feb. 27, 2018.

(51) Int. Cl. H02S 40/12; H02S 30/10; B08B 1/00

(52) U.S. Cl. CPC H02S 40/12; B08B 1/008; H02S 30/10

(57) ABSTRACT

A maintenance vehicle for cleaning a row of solar panels is provided. A vehicle frame is configured to be positioned above a solar panel and extend beyond outer edges of the solar panel. Legs are coupled to the vehicle frame and configured to extend beneath an underside of the solar panel towards a center of the underside of the solar panel. A wheel set of two or more wheels are coupled to each of the legs and configured to roll along two rows of purlins positioned parallel to the row, spaced a distance apart, and coupled to the underside of the solar panel. Each of the purlins has a vertical flange that constrains a sideways motion of the wheel set. One or more drive systems are configured to advance the maintenance vehicle along the row by rotating the wheel set along the two rows of purlins.

### CROSS-REFERENCE TO RELATED APPLICATION

This application claims priority to U.S. Provisional Application No. 62/636,051, filed Feb. 27, 2018, the entirety of which is herein incorporated by reference.

### FIELD

The current subject matter is directed to maintenance vehicles for use in connection with solar photovoltaic (PV) power plants.

### BACKGROUND

Solar photovoltaic power plants use photovoltaic panels to collect light from the sun and convert it into electric power. Solar PV power plants may require a variety of maintenance tasks to be completed regularly for proper operation of the plant. Maintenance tasks can include tasks such as cleaning the solar panels, clearing snow off the panels, trimming vegetation between rows, depositing herbicide, insecticide, or animal repellant, solar panel inspection, structural inspection, identifying individual solar panels by bar code, spraying protective coatings on electrical connection points on the backs of panels, depositing coatings on solar panels, applying a material on the ground to increase ground reflectivity, or other suitable task(s). Solar panel owners and operators face the management challenge that such maintenance activities may not provide economic benefits unless they are done at low cost. Systems and methods for executing such tasks desirably are productive in their use of human labor and deployed capital so that they can perform their tasks in an economically beneficial manner.

### SUMMARY

A maintenance vehicle for cleaning a row of solar panels is provided. A vehicle frame is configured to be positioned above a solar panel and extend beyond outer edges of the solar panel. Legs are coupled to the vehicle frame and configured to extend beneath an underside of the solar panel towards a center of the underside of the solar panel. A wheel set of two or more wheels are coupled to each of the legs and configured to roll along two rows of purlins positioned parallel to the row of solar panels. The two rows of purlins are spaced a distance apart. The two rows of purlins are coupled to the underside of the solar panel. Each of the purlins has a vertical flange that constrains a sideways motion of the wheel set. One or more drive systems are configured to advance the maintenance vehicle along the row of solar panels by rotating the wheel set along the two rows of purlins.

A maintenance vehicle for cleaning a row of solar panels is provided. A vehicle frame is configured to be positioned above a solar panel and extend beyond outer edges of the solar panel. First and second legs are coupled to the vehicle frame and configured to extend beneath an underside of the solar panel towards a center of the underside of the solar panel. The maintenance vehicle comprises first and second wheel sets of two or more wheels. First wheel holders are coupled to the first leg and the first set of two or more wheels. Second wheel holders are coupled to the second leg and the second set of two or more wheels. One or more drive systems are configured to advance the maintenance vehicle along the row of solar panels by rotating the first and second sets of two or more wheels along purlins coupled to the underside of the solar panels and extending in a direction parallel to the row of solar panels. Each of the purlins has a vertical flange that limits a motion of the first and second sets of two or more wheels in a direction perpendicular to the row of solar panels.

### BRIEF DESCRIPTION OF DRAWINGS

FIGS. 1A and 1B schematically illustrate a perspective view of a solar collector.

FIGS. 2A and 2B schematically illustrate perspective views of a maintenance vehicle which can be designed to perform maintenance tasks on a solar collector such as is described in FIGS. 1A-1B.

FIG. 3 schematically illustrates a perspective view of a system including a maintenance vehicle and a series of solar collectors aligned in a row.

FIG. 4 schematically illustrates a side view of a maintenance vehicle driving on a solar collector.

FIGS. 5A and 5B schematically illustrate an end view of a maintenance vehicle positioned on a solar collector.

FIG. 6 schematically illustrates a perspective view of a maintenance vehicle traveling on two solar collectors.

FIGS. 7A and 7B schematically illustrate perspective views of a system including a solar collector, a maintenance vehicle, and a maintenance vehicle transfer cart.

FIG. 8 illustrates a flow of operations in an exemplary method for conducting a maintenance process on the solar collector schematically illustrated in FIGS. 1A-1B with the maintenance vehicle schematically illustrated in FIGS. 2A-7B.

### DETAILED DESCRIPTION

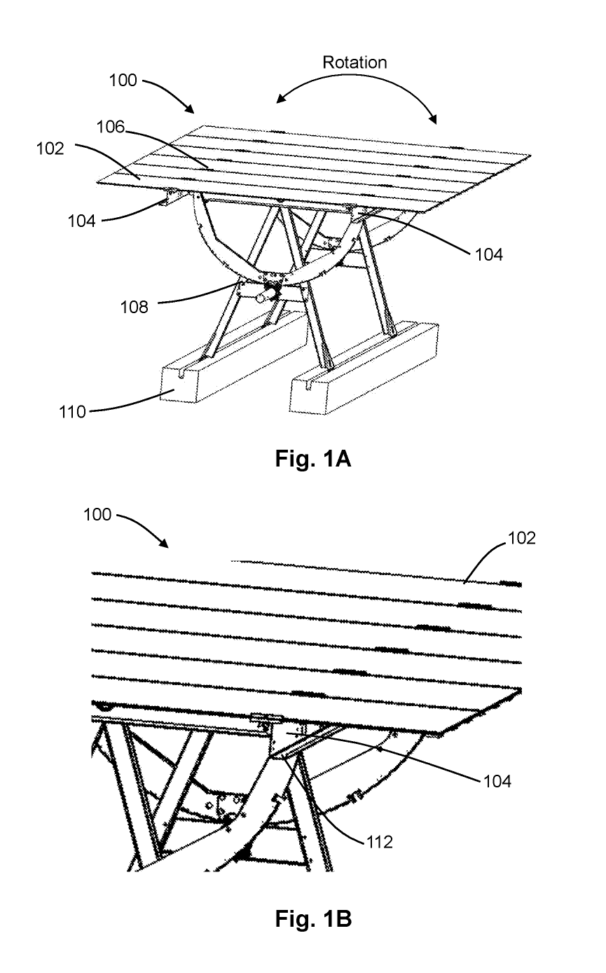

FIGS. 1A and 1B schematically illustrate a perspective view of a solar collector 100. The solar collector includes a series of solar PV panels 102. Optionally, the solar PV panels 102 can include frames. In other configurations, the solar PV panels 102 can be frameless. PV panels 102 can be mounted on two purlins 104, or alternatively, two rows of purlins 104, which can include elongated structural pieces that are positioned beneath the PV panels spaced at a distance from the outer edges of the solar panels 102, respectively. The purlins 104 can include one or more bends configured to increase stiffness and strength of the respective purlin, where the axis for the bend can be aligned with the long dimension of the purlin. The purlins 104 can be referred to as rails, stringers, support members, joists, or as other names, and can serve the purpose of supporting the solar panels 102. In some configurations, the solar panels 102 can mount onto the purlins 104 with clips 106. The clips can be or include clamps or any other mechanical fastener that helps secure the solar panels 102 to the purlins 104. The solar panels 102 can also or alternatively be fastened to the purlins 104 with adhesive or with mechanical fasteners. The purlins 104 can be fastened to a support structure 108 using suitable mechanical member(s), and support structure 108 can be supported by a foundation 110. The solar collector 100 can be configured to rotate solar PV panels 102 so as to track the sun, or the solar collector can position the panels in a fixed position that can be selected and/or optimized for the solar plant design. The foundation 110 schematically illustrated in FIG. 1A can include a ballast foundation, but the foundation can also include a foundation of driven piles or any other foundation. FIG. 1B schematically illustrates a close-up view of one of the purlins 104. Each purlin 104 can include one or more bends that form one or more surfaces 112 that can be substantially parallel to the solar panels 102 and that can support one or more wheels of a maintenance vehicle.

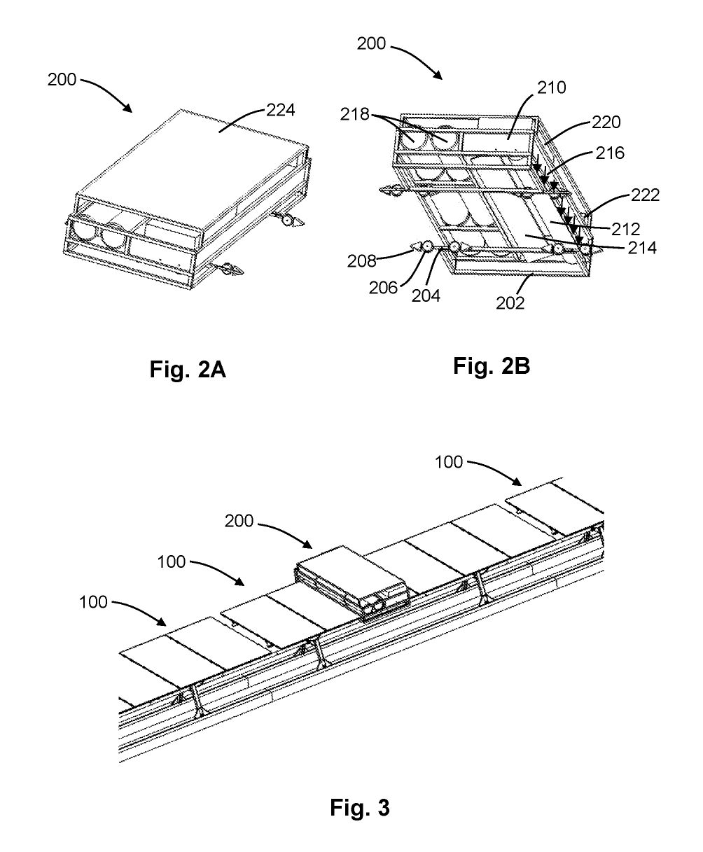

For example, FIGS. 2A and 2B schematically illustrate perspective views of a maintenance vehicle 200, which can be configured to perform maintenance tasks on a solar collector such as is described in FIGS. 1A-1B. The maintenance vehicle 200 schematically illustrated in FIGS. 2A-2B can be configured to clean solar panels; however, maintenance vehicle 200 additionally or alternatively can be configured to perform other tasks such as imaging or chemical deposition. The maintenance vehicle 200 can be designed to ride or drive on the purlins 104 of the solar collector 100. The maintenance vehicle 200 includes a vehicle frame 202. The maintenance vehicle 200 can include an image sensor coupled to the vehicle frame 202 to perform imaging. Four or more wheel sets (or trucks, bogies, or wheel holders) 204 can be mounted on the vehicle frame 202, and each wheel set can hold one or more wheels 206. The wheel sets 204 can have wheel guides 208. The wheel sets 204 can be fixed in position with respect to the vehicle frame 202, or they can be allowed a limited range of motion about one or more axes of rotation at the connection point to the vehicle frame 202. Maintenance vehicle 200 can include one or more drive systems for advancing the vehicle along solar panels 102 via rotation of wheels 206 along purlins 104. The one or more drive systems can include one or more electric motors, engines, fluid motors, or other suitable drive system(s).

Continuing with FIGS. 2A and 2B, the maintenance vehicle 200 can include a cleaning head 210, e.g., if the designated maintenance task is cleaning. The cleaning head 210 can include one or more of a brush 212, which can rotate (e.g., in a direction perpendicular to the length of the purlins 104), a wiper 214, and/or a fluids deposition system (denoted by arrows 216) configured to deposit one or more fluids onto solar PV panels 102. Deposited fluid can include one or more of water, a water-detergent solution, or another fluid. The maintenance vehicle can also include one or more tanks 218 to carry one or more fluids to be deposited and plumbing equipment (not specifically illustrated) to pump, regulate, chemically or mechanically treat, measure, and/or control the fluid(s) as the fluid(s) pass from the one or more tanks 218 to the fluids deposition system 216.

Continuing with FIGS. 2A and 2B, the maintenance vehicle 200 can include a battery module 220 to provide on-board power. Maintenance vehicle 200 can include a generator or engine to provide shaft power or electric power. The maintenance vehicle 200 can include a control system and electronic communication system 222, which can be configured to control operation of the vehicle and optionally to wirelessly communicate to an off-board control system or to other machines and/or maintenance vehicles. The maintenance vehicle 200 can include a solar panel 224 coupled to the vehicle frame 202 to provide on-board power for maintenance tasks.

FIG. 3 schematically illustrates a perspective view of a system including the maintenance vehicle 200 and a series of solar collectors 100 aligned in a row. The solar collectors can be connected together by the purlins 104 (not specifically shown in FIG. 3, but can be configured similarly as illustrated in FIGS. 1A-1B), with other structural support members, with a connected foundation, and/or by other structural members. The solar collectors 100 alternatively can be disconnected from one another can be substantially aligned in a row and positioned with a relatively short distance between the edge of one solar collector and the edge of another solar collector. A maintenance vehicle 200 is schematically illustrated as driving and/or riding on the solar collectors 100, and can be configured similarly as described with reference to FIGS. 2A-2B. The solar panels can be rotated to a horizontal position for maintenance vehicle operation. The maintenance vehicle 200 can travel while performing its maintenance task(s), or the vehicle can travel without performing a task.

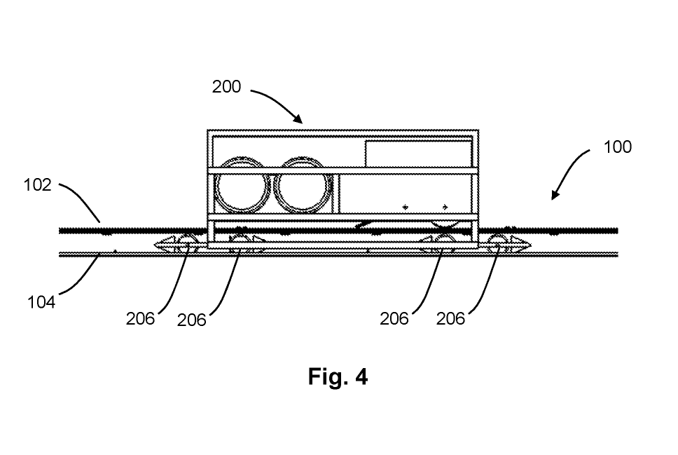

FIG. 4 schematically illustrates a side view of the maintenance vehicle 200 driving on a solar collector 100. The wheels of the maintenance vehicle 206 roll on and along one or more surfaces of the purlins 104 and beneath the solar panels 102. For example, the wheels 206 can be supported by one or more bent surfaces, i.e., flanges, 112. The one or more flanges 112 can constrain a sideways motion of the wheels 206.

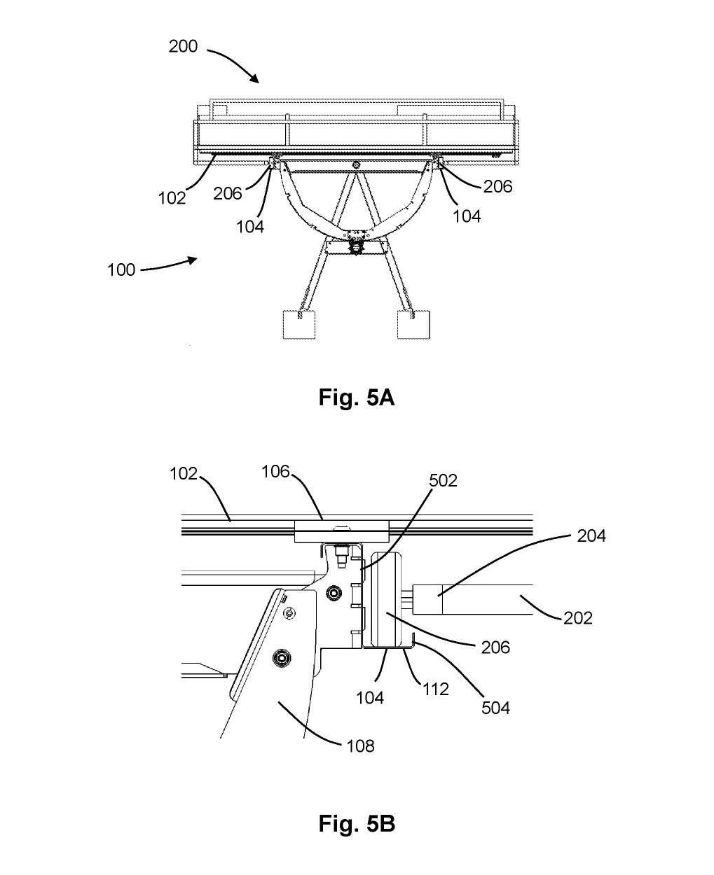

FIGS. 5A and 5B schematically illustrate an end view of the maintenance vehicle 200 positioned on a solar collector 100 that can include a row of solar panels. FIG. 5B schematically illustrates a close-up view of the wheel 206 on the purlin 104 with the wheel guides omitted for clarity. The wheel 206 is schematically illustrated as rolling on the purlin 104, specifically on the horizontal surface 112. The vehicle frame 202 can be configured to be positioned above the solar panels and extend beyond the outer edges of the solar panel 102.

Continuing with FIGS. 5A and 5B, legs 506 can be coupled to the vehicle frame 202 of the maintenance vehicle 200. The legs 506 can be coupled to the wheels 206 via wheel holders 204. The legs 506 can be configured to extend beneath an underside of the solar panel 102 from beyond the outer edges towards a center of the underside of the solar panel 102 without contacting the underside of the solar panel 102. The wheels 206 can roll along purlin 104 below the solar panel 102.

In the nonlimiting configuration illustrated in FIGS. 5A-5B, the purlin can be configured in the general shape of a “Z,” in which the top of the “Z” is coupled to the solar PV panel so as to support the panel, and the bottom of the “Z” is horizontally parallel to (and optionally horizontally offset from) the top of the Z so as to support wheel 206 beneath the panel. A vertical surface 502 of the purlin (connecting the top and bottom of the “Z” to one another) can connect to the solar collector frame 108, and the top of the purlin supports the panel clips 106. The purlin 104 can have other suitable configurations as well, such as a “C” or “S” shape. Besides the horizontal surface 112 on which the wheels 206 roll, the purlin also can include the vertical surface 502 and a vertical lip 504 that constrain the sideways motion of the wheels 206. The wheel set 204 and the vehicle frame 202 can be positioned sufficiently high as not to interfere with the purlin lip 504.

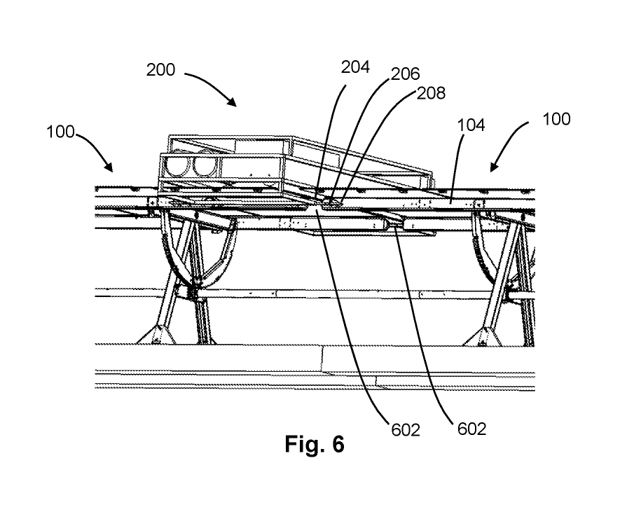

FIG. 6 schematically illustrates a perspective view of a maintenance vehicle 200 traveling on two solar collectors 100. The maintenance vehicle 200 can include two or more wheels 206 per wheel set 204. When traveling between two separate solar collectors, the wheels 206 and wheel sets 204 can be arranged such that wheels on an individual wheel set can span the gap 602 between purlins 104 on adjacent solar collectors 100. The wheel guides 208, in contact with the purlins 104, can also help the wheels 206 to be positioned correctly as the vehicle 200 travels across purlins that are spaced apart by gap 602. For example, the wheel guides 208 can be coupled to and protrude from the wheel sets 204. The wheel guides 208 can be configured to pull one of the wheels 206 onto a next purlin if the one of the two or more wheels rolls from a previous purlin into the gap 602.

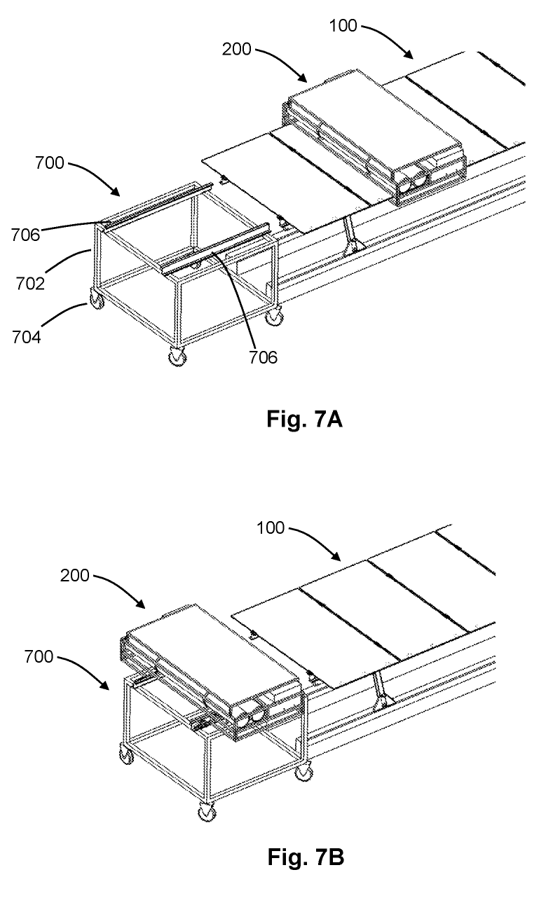

FIGS. 7A and 7B schematically illustrate perspective views of a system including a solar collector 100 for a row of solar panels 102, a maintenance vehicle 200, and a maintenance vehicle transfer cart 700. The maintenance vehicle transfer cart 700 can move along a support surface and can be used to move the maintenance vehicle 200 on and off of the solar collector 100. In FIG. 7A, the maintenance vehicle 200 is schematically illustrated as driving on the purlins of the solar collector 100, and in FIG. 7B, the maintenance vehicle 200 is schematically illustrated as parked on the maintenance vehicle transfer cart 700. The maintenance vehicle transfer cart 700 can include a support structural member 702, wheels 704, optionally which may allow the cart to turn or alternatively may not allow the cart to turn, and two purlins 706. The maintenance vehicle transfer cart 700 can be configured so that the maintenance vehicle 200 can drive from off of the purlins 104 on the solar collector 100 directly onto the purlins 706 on the cart. The maintenance vehicle transfer cart 700 can be pushed by hand. The maintenance vehicle transfer cart 700 can include a drive system and be self-propelled with electric motors, an engine and transmission, or other propulsion system. The maintenance vehicle transfer cart 700 can be directed by an operator. A movement of the maintenance vehicle transfer cart 700 can be constrained by riding on tracks on the ground (not specifically illustrated). The maintenance vehicle transfer cart 700 can be or include an autonomous vehicle configured such that a suitable control system and sensor package can direct the movement of the maintenance vehicle transfer cart 700 without human intervention.

Continuing with FIGS. 7A and 7B, the maintenance vehicle transfer cart 700 can be configured to move the maintenance vehicle 200 on and off of one or more rows of solar collectors to begin and end a maintenance process on each such row. The maintenance vehicle transfer cart 700 can also or alternatively be configured to move the maintenance vehicle 200 from one row to another or to move vehicle 200 from a given row to a fluids refill location and back to another row. Additionally, the maintenance vehicle transfer cart 700 can be configured to reverse the orientation of the maintenance vehicle 200 by rotating the cart 180°.

The vehicle frame 202 can be configured to be positioned above the solar panels and extend beyond the outer edges 708 and 710 of the solar panels 102. The outer edges 708 and 710 extend in a direction parallel to the row of solar panels 102.

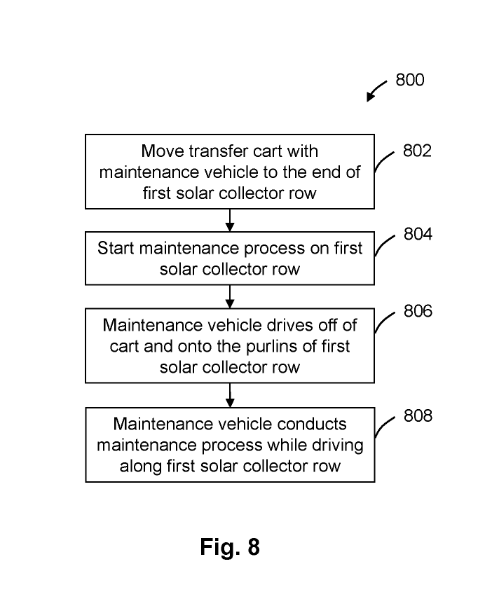

FIG. 8 illustrates a flow of operations in an exemplary method for conducting a maintenance process on the solar collector schematically illustrated in FIGS. 1A-1B with the maintenance vehicle schematically illustrated in FIGS. 2A-7B. One of ordinary skill in the art would recognize many variations, alternatives, and modifications. A method of conducting the maintenance process includes processes 802, 804, 806, and 808. At process 802, the transfer cart 700, carrying the maintenance vehicle, can be moved to the end of a first solar collector row. At process 804, the maintenance process on the first solar collector row can be initiated. At process 806, the maintenance vehicle drives off of the cart and onto the purlins of the first solar collector row. At process 808, the maintenance vehicle conducts the maintenance process while driving along the first solar collector row. Transfer cart 700 can move the maintenance vehicle to any suitable number of solar collector rows, and steps 804-808 repeated on such rows. It should be appreciated that operations in method 800 can be performed in any suitable order.

In the descriptions above and in the claims, phrases such as “at least one of” or “one or more of” can occur followed by a conjunctive list of elements or features. The term “and/or” can also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A maintenance vehicle for cleaning a row of solar panels comprising:
a vehicle frame configured to be positioned above a solar panel and extend beyond outer edges of the solar panel;
legs coupled to the vehicle frame and configured to extend beneath an underside of the solar panel towards a center of the underside of the solar panel;
a wheel set of two or more wheels coupled to each of the legs and configured to roll along two rows of purlins positioned parallel to the row of solar panels, the two rows of purlins spaced a distance apart, the two rows of purlins coupled to the underside of the solar panels, each of the purlins having a vertical flange that constrains a sideways motion of the wheel set; and
one or more drive systems configured to advance the maintenance vehicle along the row of solar panels by rotating the wheel set along the two rows of purlins.

2. The maintenance vehicle of claim 1, further comprising:
an image sensor coupled to the vehicle frame and configured to image the solar panels.

3. The maintenance vehicle of claim 1, further comprising:
a solar panel coupled to the vehicle frame to provide on-board power for maintenance tasks.

4. The maintenance vehicle of claim 1, wherein the one or more drive systems comprise one or more of electric motors, engines, or fluid motors.

5. The maintenance vehicle of claim 1, further comprising:
an electronic communication system configured to communicate wirelessly to an off-board control system and to other maintenance vehicles.

6. The maintenance vehicle of claim 1, wherein the maintenance vehicle is configured to drive from the two rows of purlins onto a maintenance vehicle transfer cart, the maintenance vehicle transfer cart configured to transport the maintenance vehicle from the row of solar panels to another row of solar panels.

7. The maintenance vehicle of claim 6, wherein the maintenance vehicle transfer cart is configured to reverse an orientation of the maintenance vehicle by rotating the maintenance vehicle transfer cart 180 degrees.

8. The maintenance vehicle of claim 1, wherein each of the purlins in the two rows of purlins comprise one of a “Z” shape, a “C” shape, or an “S” shape.

9. The maintenance vehicle of claim 1, wherein each of the purlins in the two rows of purlins are spaced a distance from the outer edges of the solar panels.

10. The maintenance vehicle of claim 1, where the solar panels are rotated to a horizontal position for maintenance vehicle operation.

11. The maintenance vehicle of claim 1, further comprising:
wheel guides coupled to and protruding from the wheel set, wherein a previous purlin and a next purlin are spaced apart by a gap, and wherein the wheel guides are configured to guide one of the two or more wheels onto the next purlin if the one of the two or more wheels rolls from the previous purlin into the gap.

12. The maintenance vehicle of claim 1, further comprising:
a cleaning head comprising at least one of:
a brush rotatable in a direction perpendicular to the two rows of purlins; or
a wiper; and
a fluids deposition system configured to deposit one or more fluids onto the solar panels.

13. The maintenance vehicle of claim 12, further comprising:
one or more tanks that carry the one or more fluids to be deposited on the solar panels; and
plumbing equipment configured to performing at least one of pumping, regulating, chemically or mechanically treating, measuring, or controlling the one or more fluids as the one or more fluids pass from the one or more tanks to the fluids deposition system.

14. A maintenance vehicle for cleaning a row of solar panels, the maintenance vehicle comprising:
a vehicle frame configured to be positioned above a solar panel and extend beyond outer edges of the solar panel;
first and second legs coupled to the vehicle frame and configured to extend beneath an underside of the solar panel towards a center of the underside of the solar panel;
first and second wheel sets of two or more wheels;
first wheel holders coupled to the first leg and the first set of two or more wheels;
second wheel holders coupled to the second leg and the second set of two or more wheels; and
one or more drive systems configured to advance the maintenance vehicle along the row of solar panels by rotating the first and second sets of two or more wheels along purlins coupled to the underside of the solar panels and extending in a direction parallel to the row of solar panels, each of the purlins having a vertical flange that limits a motion of the first and second sets of two or more wheels in a direction perpendicular to the row of solar panels.

15. The maintenance vehicle of claim 14, wherein each of the purlins comprise one of a “Z” shape, a “C” shape, or an “S” shape.

16. The maintenance vehicle of claim 14, wherein the maintenance vehicle is configured to drive from the two rows of purlins onto a maintenance vehicle transfer cart, the maintenance vehicle transfer cart configured to transport the maintenance vehicle from the row of solar panels to another row of solar panels.

17. The maintenance vehicle of claim 16, wherein the maintenance vehicle transfer cart is configured to reverse an orientation of the maintenance vehicle by rotating the maintenance vehicle transfer cart 180 degrees.

18. The maintenance vehicle of claim 14, where the solar panels are rotated to a horizontal position for maintenance vehicle operation.

19. The maintenance vehicle of claim 14, further comprising:
wheel guides coupled to and protruding from each of the first and second wheel holders, wherein a previous purlin and a next purlin are spaced apart by a gap, and wherein the wheel guides are configured to guide one of the two or more wheels onto the next purlin if the one of the two or more wheels rolls from the previous purlin into the gap.

20. The maintenance vehicle of claim 14, wherein the one or more drive systems comprise one or more of electric motors, engines, or fluid motors.
